(19) United States
(12) Patent Application Publication
(10) Pub. No.: US 2026/0127783 A1
(43) Pub. Date: May 7, 2026

(54) VISUAL ENHANCEMENT OF SEE-THROUGH IMAGE SEQUENCES FOR EXTENDED REALITY (XR) OR OTHER APPLICATIONS

(71) Applicant: Samsung Electronics Co., Ltd., Suwon-si (KR)

(72) Inventor: Yingen Xiong, Mountain View, CA (US)

(21) Appl. No.: 19/065,788

(22) Filed: Feb. 27, 2025

Related U.S. Application Data
(60) Provisional application No. 63/716,147, filed on Nov. 4, 2024.

(51) Int. Cl. G06T 11/00; G06T 7/30

(52) U.S. Cl. CPC G06T 11/10; G06T 7/30; G06T 2207/20048

(57) ABSTRACT

An apparatus includes at least one imaging sensor configured to capture a sequence of image frames. The apparatus also includes at least one processing device configured, for each of at least some of the captured image frames, to generate a lightness model associated with the captured image frame, apply the lightness model to the captured image frame in order to generate a modified captured image frame, and render an image for display based on the modified captured image frame. The lightness model is based on (i) one or more previous visually-enhanced image frames associated with one or more previous image frames in the sequence and (ii) one or more previous lightness models associated with the one or more previous visually-enhanced image frames.

### CROSS-REFERENCE TO RELATED APPLICATION AND PRIORITY CLAIM

This application claims priority under 35 U.S.C. § 119 (e) to U.S. Provisional Patent Application No. 63/716,147 filed on Nov. 4, 2024. This provisional patent application is hereby incorporated by reference in its entirety.

### TECHNICAL FIELD

This disclosure relates generally to extended reality (XR) systems and processes. More specifically, this disclosure relates to visual enhancement of see-through image sequences for XR or other applications.

### BACKGROUND

Extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

### SUMMARY

This disclosure relates to visual enhancement of see-through image sequences for extended reality (XR) or other applications.

In a first embodiment, an apparatus includes at least one imaging sensor configured to capture a sequence of image frames. The apparatus also includes at least one processing device configured, for each of at least some of the captured image frames, to generate a lightness model associated with the captured image frame, apply the lightness model to the captured image frame in order to generate a modified captured image frame, and render an image for display based on the modified captured image frame. The lightness model is based on (i) one or more previous visually-enhanced image frames associated with one or more previous image frames in the sequence and (ii) one or more previous lightness models associated with the one or more previous visually-enhanced image frames.

In a second embodiment, a method includes obtaining a sequence of captured image frames using at least one imaging sensor. The method also includes, for each of at least some of the captured image frames, generating a lightness model associated with the captured image frame, applying the lightness model to the captured image frame in order to generate a modified captured image frame, and rendering an image for display based on the modified captured image frame. The lightness model is based on (i) one or more previous visually-enhanced image frames associated with one or more previous image frames in the sequence and (ii) one or more previous lightness models associated with the one or more previous visually-enhanced image frames.

In a third embodiment, a non-transitory machine readable medium contains instructions that when executed cause at least one processor of an electronic device to obtain a sequence of captured image frames using at least one imaging sensor. The non-transitory machine readable medium also contains instructions that when executed cause the at least one processor, for each of at least some of the captured image frames, to generate a lightness model associated with the captured image frame, apply the lightness model to the captured image frame in order to generate a modified captured image frame, and render an image for display based on the modified captured image frame. The lightness model is based on (i) one or more previous visually-enhanced image frames associated with one or more previous image frames in the sequence and (ii) one or more previous lightness models associated with the one or more previous visually-enhanced image frames.

Any one or any combination of the following features may be used with the first, second, or third embodiment. The lightness model for each of at least some of the captured image frames may be generated by identifying (i) one or more parameters of a lightness transform function based on one or more properties of the at least one imaging sensor and (ii) an exposure ratio map associated with the captured image frame. For each of at least some of the captured image frames, both the lightness model and a response model may be applied in order to generate the modified captured image frame, and the response model may be associated with the at least one imaging sensor. The response model may be generated by (i) obtaining color image frames captured using the at least one imaging sensor (where different color image frames can be captured using different exposure settings) and (ii) identifying one or more parameters of the response model based on the color image frames. A transformation may be applied to the modified captured image frame in order to generate a transformed image frame, and the transformed image frame may be rendered in order to render the image for display. The lightness model for each of at least some of the captured image frames may be generated by (i) performing registration between the captured image frame and the one or more previous visually-enhanced image frames to obtain pixel correspondences between the image frames and (ii) determining one or more parameters of the lightness model based on the pixel correspondences. The modified captured image frame may be saved as part of a sequence of previous visually-enhanced image frames, the lightness model may be saved as part of a sequence of previous lightness models, and an additional image frame in the sequence of image frames may be processed based on the sequence of previous visually-enhanced image frames and the sequence of previous lightness models. At least one predefined lightness model may be applied to one or more initial captured image frames in the sequence in order to generate at least one of the one or more previous visually-enhanced image frames, and the at least one predefined lightness model may be used as at least one of the one or more previous lightness models.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

As used here, terms and phrases such as “have,” “may have,” “include,” or “may include” a feature (like a number, function, operation, or component such as a part) indicate the existence of the feature and do not exclude the existence of other features. Also, as used here, the phrases “A or B,” “at least one of A and/or B,” or “one or more of A and/or B” may include all possible combinations of A and B. For example, “A or B,” “at least one of A and B,” and “at least one of A or B” may indicate all of (1) including at least one A, (2) including at least one B, or (3) including at least one A and at least one B. Further, as used here, the terms “first” and “second” may modify various components regardless of importance and do not limit the components. These terms are only used to distinguish one component from another. For example, a first user device and a second user device may indicate different user devices from each other, regardless of the order or importance of the devices. A first component may be denoted a second component and vice versa without departing from the scope of this disclosure.

It will be understood that, when an element (such as a first element) is referred to as being (operatively or communicatively) “coupled with/to” or “connected with/to” another element (such as a second element), it can be coupled or connected with/to the other element directly or via a third element. In contrast, it will be understood that, when an element (such as a first element) is referred to as being “directly coupled with/to” or “directly connected with/to” another element (such as a second element), no other element (such as a third element) intervenes between the element and the other element.

As used here, the phrase “configured (or set) to” may be interchangeably used with the phrases “suitable for,” “having the capacity to,” “designed to,” “adapted to,” “made to,” or “capable of” depending on the circumstances. The phrase “configured (or set) to” does not essentially mean “specifically designed in hardware to.” Rather, the phrase “configured to” may mean that a device can perform an operation together with another device or parts. For example, the phrase “processor configured (or set) to perform A, B, and C” may mean a generic-purpose processor (such as a CPU or application processor) that may perform the operations by executing one or more software programs stored in a memory device or a dedicated processor (such as an embedded processor) for performing the operations.

The terms and phrases as used here are provided merely to describe some embodiments of this disclosure but not to limit the scope of other embodiments of this disclosure. It is to be understood that the singular forms “a,” “an,” and “the” include plural references unless the context clearly dictates otherwise. All terms and phrases, including technical and scientific terms and phrases, used here have the same meanings as commonly understood by one of ordinary skill in the art to which the embodiments of this disclosure belong. It will be further understood that terms and phrases, such as those defined in commonly-used dictionaries, should be interpreted as having a meaning that is consistent with their meaning in the context of the relevant art and will not be interpreted in an idealized or overly formal sense unless expressly so defined here. In some cases, the terms and phrases defined here may be interpreted to exclude embodiments of this disclosure.

Examples of an “electronic device” according to embodiments of this disclosure may include at least one of a smartphone, a tablet personal computer (PC), a mobile phone, a video phone, an e-book reader, a desktop PC, a laptop computer, a netbook computer, a workstation, a personal digital assistant (PDA), a portable multimedia player (PMP), an MP3 player, a mobile medical device, a camera, or a wearable device (such as smart glasses, a head-mounted device (HMD), electronic clothes, an electronic bracelet, an electronic necklace, an electronic accessory, an electronic tattoo, a smart mirror, or a smart watch). Other examples of an electronic device include a smart home appliance. Examples of the smart home appliance may include at least one of a television, a digital video disc (DVD) player, an audio player, a refrigerator, an air conditioner, a cleaner, an oven, a microwave oven, a washer, a dryer, an air cleaner, a set-top box, a home automation control panel, a security control panel, a TV box (such as SAMSUNG HOMESYNC, APPLETV, or GOOGLE TV), a smart speaker or speaker with an integrated digital assistant (such as SAMSUNG GALAXY HOME, APPLE HOMEPOD, or AMAZON ECHO), a gaming console (such as an XBOX, PLAYSTATION, or NINTENDO), an electronic dictionary, an electronic key, a camcorder, or an electronic picture frame. Still other examples of an electronic device include at least one of various medical devices (such as diverse portable medical measuring devices (like a blood sugar measuring device, a heartbeat measuring device, or a body temperature measuring device), a magnetic resource angiography (MRA) device, a magnetic resource imaging (MRI) device, a computed tomography (CT) device, an imaging device, or an ultrasonic device), a navigation device, a global positioning system (GPS) receiver, an event data recorder (EDR), a flight data recorder (FDR), an automotive infotainment device, a sailing electronic device (such as a sailing navigation device or a gyro compass), avionics, security devices, vehicular head units, industrial or home robots, automatic teller machines (ATMs), point of sales (POS) devices, or Internet of Things (IoT) devices (such as a bulb, various sensors, electric or gas meter, sprinkler, fire alarm, thermostat, street light, toaster, fitness equipment, hot water tank, heater, or boiler). Other examples of an electronic device include at least one part of a piece of furniture or building/structure, an electronic board, an electronic signature receiving device, a projector, or various measurement devices (such as devices for measuring water, electricity, gas, or electromagnetic waves). Note that, according to various embodiments of this disclosure, an electronic device may be one or a combination of the above-listed devices. According to some embodiments of this disclosure, the electronic device may be a flexible electronic device. The electronic device disclosed here is not limited to the above-listed devices and may include any other electronic devices now known or later developed.

In the following description, electronic devices are described with reference to the accompanying drawings, according to various embodiments of this disclosure. As used here, the term “user” may denote a human or another device (such as an artificial intelligent electronic device) using the electronic device.

Definitions for other certain words and phrases may be provided throughout this patent document. Those of ordinary skill in the art should understand that in many if not most instances, such definitions apply to prior as well as future uses of such defined words and phrases.

None of the description in this application should be read as implying that any particular element, step, or function is an essential element that must be included in the claim scope. The scope of patented subject matter is defined only by the claims. Moreover, none of the claims is intended to invoke 35 U.S.C. § 112 (f) unless the exact words “means for” are followed by a participle. Use of any other term, including without limitation “mechanism,” “module,” “device,” “unit,” “component,” “element,” “member,” “apparatus,” “machine,” “system,” “processor,” or “controller,” within a claim is understood by the Applicant to refer to structures known to those skilled in the relevant art and is not intended to invoke 35 U.S.C. § 112 (f).

### BRIEF DESCRIPTION OF THE DRAWINGS

For a more complete understanding of this disclosure and its advantages, reference is now made to the following description taken in conjunction with the accompanying drawings, in which:

FIG. 1 illustrates an example network configuration including an electronic device in accordance with this disclosure;

FIG. 2 illustrates an example process for visual enhancement of see-through image sequences for extended reality (XR) or other applications in accordance with this disclosure;

FIGS. 3A through 3C illustrate example functions in the process of FIG. 2 in accordance with this disclosure;

FIG. 4 illustrates an example architecture supporting visual enhancement of see-through image sequences for XR or other applications in accordance with this disclosure;

FIG. 5 illustrates an example technique for visual enhancement of image frames in a see-through image sequence in accordance with this disclosure;

FIG. 6 illustrates an example technique for improving a current lightness model based on one or more prior lightness models in accordance with this disclosure;

FIGS. 7A and 7B illustrate example results obtainable using visual enhancement of see-through image sequences in accordance with this disclosure; and

FIG. 8 illustrates an example method for visual enhancement of see-through image sequences for XR or other applications in accordance with this disclosure.

### DETAILED DESCRIPTION

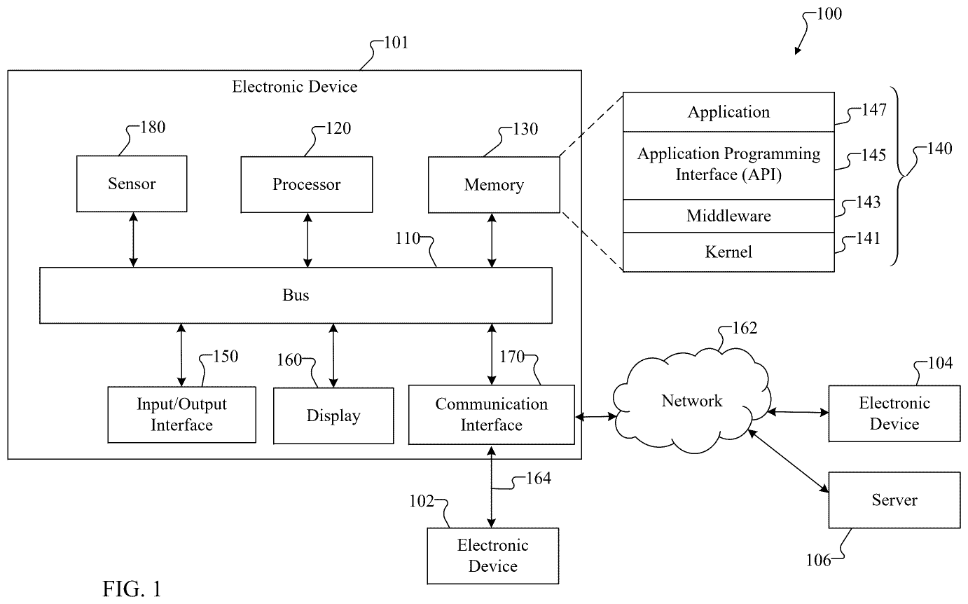

FIGS. 1 through 8, discussed below, and the various embodiments of this disclosure are described with reference to the accompanying drawings. However, it should be appreciated that this disclosure is not limited to these embodiments, and all changes and/or equivalents or replacements thereto also belong to the scope of this disclosure. The same or similar reference denotations may be used to refer to the same or similar elements throughout the specification and the drawings.

As noted above, extended reality (XR) systems are becoming more and more popular over time, and numerous applications have been and are being developed for XR systems. Some XR systems (such as augmented reality or “AR” systems and mixed reality or “MR” systems) can enhance a user's view of his or her current environment by overlaying digital content (such as information or virtual objects) over the user's view of the current environment. For example, some XR systems can often seamlessly blend virtual objects generated by computer graphics with real-world scenes.

Optical see-through (OST) XR systems refer to XR systems in which users directly view real-world scenes through head-mounted devices (HMDs). Unfortunately, OST XR systems face many challenges that can limit their adoption. Some of these challenges include limited fields of view, limited usage spaces (such as indoor-only usage), failure to display fully-opaque black objects, and usage of complicated optical pipelines that may require projectors, waveguides, and other optical elements. In contrast to OST XR systems, video sec-through (VST) XR systems (also called “passthrough” XR systems) present users with generated video sequences of real-world scenes. VST XR systems can be built using virtual reality (VR) technologies and can have various advantages over OST XR systems. For example, VST XR systems can provide wider fields of view and can provide improved contextual augmented reality.

A VST XR device often includes one or more imaging sensors (also called “see-through cameras”) that capture high-resolution image frames of a user's surrounding environment. These image frames are processed in an image processing pipeline in order to generate final rendered views of the user's surrounding environment. Unfortunately, VST XR devices can suffer from various problems. One problem is that the image quality of the captured image frames can be affected by conditions in the surrounding environment and properties of the imaging sensors themselves. For example, when inadequate lighting is available in the user's surrounding environment, captured image frames can appear dark and noisy, which makes it difficult for the user to discern content in the captured environment and can even cause user discomfort.

This disclosure provides various techniques supporting visual enhancement of see-through image sequences for XR or other applications. As described in more detail below, a sequence of image frames can be obtained using at least one imaging sensor. For each of at least some of the captured image frames, a lightness model associated with the captured image frame can be generated and applied to the captured image frame in order to generate a modified captured image frame, and an image can be rendered for display based on the modified captured image frame. Each lightness model can be based on (i) one or more previous visually-enhanced image frames associated with one or more previous image frames in the sequence and (ii) one or more previous lightness models associated with the one or more previous visually-enhanced image frames. In some cases, for each of at least some of the captured image frames, both the lightness model and a response model may be applied in order to generate the modified captured image frame, where the response model is associated with the at least one imaging sensor. This process can be repeated for any number of image frames in the sequence. In some cases, at least one predefined lightness model can be applied to one or more initial captured image frames in the sequence in order to generate at least one of the one or more previous visually-enhanced image frames, and the at least one predefined lightness model can be used as at least one of the one or more previous lightness models.

In this way, the disclosed techniques can be used to provide visual enhancement of image frames captured within a sequence of image frames. For example, the disclosed techniques can enable improved images to be rendered and displayed to users, even when those images are based on image frames that are noisy and captured in low-light conditions. As a result, this can significantly improve user experience, even in low-light environments. Moreover, these techniques allow lightness transform models to be determined in an online manner directly from a sequence of image frames, meaning the lightness transform models can be identified using the image frames in the sequence and applied to the same image frames. Among other things, this can enable use of the disclosed techniques in XR applications or other applications where significant latency is undesirable.

FIG. 1 illustrates an example network configuration 100 including an electronic device in accordance with this disclosure. The embodiment of the network configuration 100 shown in FIG. 1 is for illustration only. Other embodiments of the network configuration 100 could be used without departing from the scope of this disclosure.

According to embodiments of this disclosure, an electronic device 101 is included in the network configuration 100. The electronic device 101 can include at least one of a bus 110, a processor 120, a memory 130, an input/output (I/O) interface 150, a display 160, a communication interface 170, and a sensor 180. In some embodiments, the electronic device 101 may exclude at least one of these components or may add at least one other component. The bus 110 includes a circuit for connecting the components 120-180 with one another and for transferring communications (such as control messages and/or data) between the components.

The processor 120 includes one or more processing devices, such as one or more microprocessors, microcontrollers, digital signal processors (DSPs), application specific integrated circuits (ASICs), or field programmable gate arrays (FPGAs). In some embodiments, the processor 120 includes one or more of a central processing unit (CPU), an application processor (AP), a communication processor (CP), a graphics processor unit (GPU), or a neural processing unit (NPU). The processor 120 is able to perform control on at least one of the other components of the electronic device 101 and/or perform an operation or data processing relating to communication or other functions. As described below, the processor 120 may perform one or more functions related to visual enhancement of see-through image sequences for XR or other applications.

The memory 130 can include a volatile and/or non-volatile memory. For example, the memory 130 can store commands or data related to at least one other component of the electronic device 101. According to embodiments of this disclosure, the memory 130 can store software and/or a program 140. The program 140 includes, for example, a kernel 141, middleware 143, an application programming interface (API) 145, and/or an application program (or “application”) 147. At least a portion of the kernel 141, middleware 143, or API 145 may be denoted an operating system (OS).

The kernel 141 can control or manage system resources (such as the bus 110, processor 120, or memory 130) used to perform operations or functions implemented in other programs (such as the middleware 143, API 145, or application 147). The kernel 141 provides an interface that allows the middleware 143, the API 145, or the application 147 to access the individual components of the electronic device 101 to control or manage the system resources. The application 147 may include one or more applications that, among other things, perform visual enhancement of see-through image sequences for XR or other applications. These functions can be performed by a single application or by multiple applications that each carries out one or more of these functions. The middleware 143 can function as a relay to allow the API 145 or the application 147 to communicate data with the kernel 141, for instance. A plurality of applications 147 can be provided. The middleware 143 is able to control work requests received from the applications 147, such as by allocating the priority of using the system resources of the electronic device 101 (like the bus 110, the processor 120, or the memory 130) to at least one of the plurality of applications 147. The API 145 is an interface allowing the application 147 to control functions provided from the kernel 141 or the middleware 143. For example, the API 145 includes at least one interface or function (such as a command) for filing control, window control, image processing, or text control.

The I/O interface 150 serves as an interface that can, for example, transfer commands or data input from a user or other external devices to other component(s) of the electronic device 101. The I/O interface 150 can also output commands or data received from other component(s) of the electronic device 101 to the user or the other external device.

The display 160 includes, for example, a liquid crystal display (LCD), a light emitting diode (LED) display, an organic light emitting diode (OLED) display, a quantum-dot light emitting diode (QLED) display, a microelectromechanical systems (MEMS) display, or an electronic paper display. The display 160 can also be a depth-aware display, such as a multi-focal display. The display 160 is able to display, for example, various contents (such as text, images, videos, icons, or symbols) to the user. The display 160 can include a touchscreen and may receive, for example, a touch, gesture, proximity, or hovering input using an electronic pen or a body portion of the user.

The communication interface 170, for example, is able to set up communication between the electronic device 101 and an external electronic device (such as a first electronic device 102, a second electronic device 104, or a server 106). For example, the communication interface 170 can be connected with a network 162 or 164 through wireless or wired communication to communicate with the external electronic device. The communication interface 170 can be a wired or wireless transceiver or any other component for transmitting and receiving signals.

The wireless communication is able to use at least one of, for example, WiFi, long term evolution (LTE), long term evolution-advanced (LTE-A), 5th generation wireless system (5G), millimeter-wave or 60 GHz wireless communication, Wireless USB, code division multiple access (CDMA), wideband code division multiple access (WCDMA), universal mobile telecommunication system (UMTS), wireless broadband (WiBro), or global system for mobile communication (GSM), as a communication protocol. The wired connection can include, for example, at least one of a universal serial bus (USB), high definition multimedia interface (HDMI), recommended standard 232 (RS-232), or plain old telephone service (POTS). The network 162 or 164 includes at least one communication network, such as a computer network (like a local area network (LAN) or wide area network (WAN)), Internet, or a telephone network.

The electronic device 101 further includes one or more sensors 180 that can meter a physical quantity or detect an activation state of the electronic device 101 and convert metered or detected information into an electrical signal. For example, the sensor(s) 180 can include cameras or other imaging sensors, which may be used to capture image frames of scenes. The sensor(s) 180 can also include one or more buttons for touch input, one or more microphones, a depth sensor, a gesture sensor, a gyroscope or gyro sensor, an air pressure sensor, a magnetic sensor or magnetometer, an acceleration sensor or accelerometer, a grip sensor, a proximity sensor, a color sensor (such as a red green blue (RGB) sensor), a bio-physical sensor, a temperature sensor, a humidity sensor, an illumination sensor, an ultraviolet (UV) sensor, an electromyography (EMG) sensor, an electroencephalogram (EEG) sensor, an electrocardiogram (ECG) sensor, an infrared (IR) sensor, an ultrasound sensor, an iris sensor, or a fingerprint sensor. Moreover, the sensor(s) 180 can include one or more position sensors, such as an inertial measurement unit that can include one or more accelerometers, gyroscopes, and other components. In addition, the sensor(s) 180 can include a control circuit for controlling at least one of the sensors included here. Any of these sensor(s) 180 can be located within the electronic device 101.

In some embodiments, the electronic device 101 can be a wearable device or an electronic device-mountable wearable device (such as an HMD). For example, the electronic device 101 may represent an XR wearable device, such as a headset or smart eyeglasses. In other embodiments, the first external electronic device 102 or the second external electronic device 104 can be a wearable device or an electronic device-mountable wearable device (such as an HMD). In those other embodiments, when the electronic device 101 is mounted in the electronic device 102 (such as the HMD), the electronic device 101 can communicate with the electronic device 102 through the communication interface 170. The electronic device 101 can be directly connected with the electronic device 102 to communicate with the electronic device 102 without involving with a separate network.

The first and second external electronic devices 102 and 104 and the server 106 each can be a device of the same or a different type from the electronic device 101. According to certain embodiments of this disclosure, the server 106 includes a group of one or more servers. Also, according to certain embodiments of this disclosure, all or some of the operations executed on the electronic device 101 can be executed on another or multiple other electronic devices (such as the electronic devices 102 and 104 or server 106). Further, according to certain embodiments of this disclosure, when the electronic device 101 should perform some function or service automatically or at a request, the electronic device 101, instead of executing the function or service on its own or additionally, can request another device (such as electronic devices 102 and 104 or server 106) to perform at least some functions associated therewith. The other electronic device (such as electronic devices 102 and 104 or server 106) is able to execute the requested functions or additional functions and transfer a result of the execution to the electronic device 101. The electronic device 101 can provide a requested function or service by processing the received result as it is or additionally. To that end, a cloud computing, distributed computing, or client-server computing technique may be used, for example. While FIG. 1 shows that the electronic device 101 includes the communication interface 170 to communicate with the external electronic device 104 or server 106 via the network 162 or 164, the electronic device 101 may be independently operated without a separate communication function according to some embodiments of this disclosure.

The server 106 can include the same or similar components as the electronic device 101 (or a suitable subset thereof). The server 106 can support to drive the electronic device 101 by performing at least one of operations (or functions) implemented on the electronic device 101. For example, the server 106 can include a processing module or processor that may support the processor 120 implemented in the electronic device 101. As described below, the server 106 may perform one or more functions related to visual enhancement of see-through image sequences for XR or other applications.

Although FIG. 1 illustrates one example of a network configuration 100 including an electronic device 101, various changes may be made to FIG. 1. For example, the network configuration 100 could include any number of each component in any suitable arrangement. In general, computing and communication systems come in a wide variety of configurations, and FIG. 1 does not limit the scope of this disclosure to any particular configuration. Also, while FIG. 1 illustrates one operational environment in which various features disclosed in this patent document can be used, these features could be used in any other suitable system.

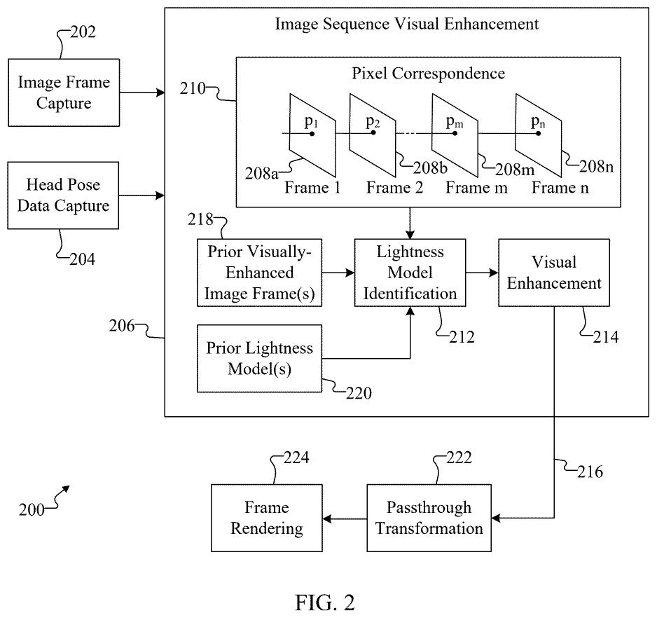

FIG. 2 illustrates an example process 200 for visual enhancement of see-through image sequences for XR or other applications in accordance with this disclosure. For case of explanation, the process 200 shown in FIG. 2 is described as being performed using the electronic device 101 in the network configuration 100 shown in FIG. 1. However, the process 200 shown in FIG. 2 may be performed using any other suitable device(s) and in any other suitable system(s).

As shown in FIG. 2, the process 200 includes an image frame capture operation 202 and a head pose data capture operation 204. The image frame capture operation 202 generally operates to obtain image frames captured by the electronic device 101, such as image frames captured using one or more imaging sensors 180 of the electronic device 101. The captured image frames may include image frames of a scene captured by forward-facing or other imaging sensors 180 of the electronic device 101. In some cases, these image frames may represent high-resolution color image frames. Any suitable pre-processing of the captured image frames may be performed here.

The head pose data capture operation 204 generally operates to obtain information related to the pose of the user's head while the electronic device 101 is being used. The head pose information may be obtained from any suitable source(s), such as from one or more positional sensors like at least one IMU. In some cases, the head pose information may be expressed using six degrees of freedom, such as three translation values and three rotation values. The three translation values may identify movement of the user's head along three orthogonal axes, and the three rotation values may identify rotation of the user's head about the three orthogonal axes. Note, however, that the head pose information may have any other suitable form. Any suitable pre-processing of the head pose data may be performed here.

An image sequence visual enhancement operation 206 generally operates to process and visually enhance captured image frames in a sequence of image frames obtained by the image frame capture operation 202. Part of the visual enhancement functionality can be based on the user's head pose as identified by the head pose data capture operation 204. In this example, the image sequence visual enhancement operation 206 obtains a sequence of image frames 208a-208n, which can capture the same general scene around the user of the electronic device 101. The sequence of image frames 208a-208n may include any suitable number of image frames.

The image frames 208a-208n are processed using a pixel correspondence function 210, which generally operates to identify locations of pixels in the image frames 208a-208n associated with common points in a scene. In this example, for instance, the pixel correspondence function 210 can determine that a point within the scene appears at a location of pixel p₁ in the image frame 208a, a location of pixel p₂ in the image frame 208b, a location of pixel pₘ in the image frame 208m, and a location of pixel pₙ in the image frame 208n. This can be repeated for any number of pixels within the image frames 208a-208n. The pixel correspondence function 210 can use any suitable technique(s) to identify locations of pixels in image frames associated with common points in a scene.

The pixel correspondences identified by the pixel correspondence function 210 are provided to a lightness model identification function 212, which generally operates to identify a lightness model for each of at least some of the image frames 208a-208n in the sequence. Each lightness model may include or represent a lightness transform function that defines how the brightness of at least one of the image frames 208a-208n may be adjusted, such as when positive values in the lightness model indicate pixels are to be brightened and negative values in the lightness model indicate pixels are to be darkened. Each of at least some of the image frames 208a-208n may be associated with its own lightness model, multiple ones of the image frames 208a-208n may be associated with a common lightness model, or a combination of both may be used. In some cases, for instance, the same lightness model may be reused if the user's head pose does not change or changes in an insignificant manner during capture of multiple image frames.

A visual enhancement operation 214 generally operates to apply lightness models generated by the lightness model identification function 212 to at least some of the image frames 208a-208n in the sequence. For example, the visual enhancement operation 214 may brighten or darken the pixels of each of at least some of the image frames 208a-208n based on the lightness models associated with those image frames. In some embodiments, the visual enhancement operation 214 may apply both a lightness model and a response model to each of at least some of the image frames 208a-208n. A response model may include or represent a response function that defines a mapping of scene irradiance to image brightness or intensity based on the imaging sensor(s) 180 used to capture the image frames. The visual enhancement operation 214 can use any suitable technique(s) to enhance image frames based on lightness models. In some cases, for instance, the lightness models may be used to apply brightness gains (positive or negative) at a per-pixel level of the image frames 208a-208n. In this way, the visual enhancement operation 214 generates enhanced image frames 216, which represent enhanced or improved versions of at least some of the image frames 208a-208n.

In some embodiments, the lightness model identification function 212 may generate an initial lightness model for each of at least some of the image frames 208a-208n in the sequence and optionally modify that initial lightness model based on (i) a sequence of one or more prior enhanced image frames 218 (which represent one or more of the enhanced image frames 216) and (ii) a sequence of one or more prior lightness models 220 (which are associated with the one or more prior enhanced image frames 218). For example, the initial lightness model for an image frame may be generated using (i) one or more parameters of a lightness transform function based on one or more properties of the at least one imaging sensor 180 used to capture that image frame and (ii) an exposure ratio map associated with that image frame. An exposure ratio map may identify a desired level of exposure for each pixel of a corresponding image frame.

Once generated, the initial lightness model for an image frame may be modified using the one or more prior enhanced image frames 218 and the one or more prior lightness models 220 (which are associated with one or more preceding image frames in the sequence). Thus, for instance, the lightness model identification function 212 may modify the initial lightness model created for the image frame 208b using the enhanced version of the image frame 208a and the lightness model used to generate the enhanced version of the image frame 208a. The lightness model identification function 212 may modify the initial lightness model created for the image frame 208n using one or more enhanced versions of one or more of the image frames 208a-208m and one or more of the lightness models used to generate the enhanced version(s) of one or more of the image frames 208a-208m. As described below, the generation of the lightness models can often improve over time, meaning the enhanced versions of later image frames in the sequence can often have more improvement compared to earlier image frames in the sequence.

Since the first image frame 208a (or the first few image frames) in the sequence may not have a prior enhanced image frame or a prior lightness model, the lightness model identification function 212 may use at least one predefined lightness model to process the initial image frame(s) in the sequence. For example, the at least one predefined lightness model may be stored in a memory 130 of the electronic device 101, retrieved by the lightness model identification function 212, and applied by the visual enhancement operation 214 to produce the first enhanced image frame 216 or the first few enhanced image frames 216. While the at least one predefined lightness model may be predetermined at the time of use, the at least one predefined lightness model may be updated over time. The one or more initial enhanced image frames 216 may be saved to the sequence of prior enhanced image frames 218 and used during processing of subsequent image frames. The one or more predefined lightness models may also be saved to the sequence of prior lightness models 220 and used during processing of subsequent image frames. Example techniques for generating and applying lightness models, generating and applying response models, and using the prior enhanced image frames 218 and the prior lightness models 220 are provided below.

A passthrough transformation operation 222 generally operates to apply one or more transformations to the enhanced image frames 216 in order to generate transformed image frames. For example, the passthrough transformation operation 222 may be used to compensate for things like registration and parallax errors, which may be caused by factors like differences between the positions of the imaging sensor(s) 180 and the user's eyes. As particular examples, the passthrough transformation operation 222 may apply a rotation and/or a translation to each enhanced image frame 216 in order to compensate for these or other types of issues. Ideally, the transformations give the appearance that the images presented to the user are captured at the locations of the user's eyes 206, when the image frames in reality are captured at one or more different locations. Often times, the rotation and/or translation can be derived mathematically based on the position and angle of each imaging sensor 180 and the expected or actual positions of the user's eyes. In some cases, the transformations are static (since these positions and angles will not change), allowing passthrough transformations to be applied quickly.

A frame rendering operation 224 generally operates to create final views of the scene captured in the transformed image frames generated by the passthrough transformation operation 222. The frame rendering operation 224 can also render the final views for presentation to a user of the electronic device 101. For example, the frame rendering operation 224 may process the transformed image frames and perform any additional refinements or modifications needed or desired, and the resulting images can represent the final views of the scene. For instance, a 3D-to-2D warping can be used to warp the final views of the scene into 2D images. The frame rendering operation 224 can also present the rendered images to the user. For example, the frame rendering operation 224 can render the images into a form suitable for transmission to at least one display 160 and can initiate display of the rendered images, such as by providing the rendered images to one or more displays 160. In some cases, there may be a single display 160 on which the rendered images are presented for viewing by the user, such as where each eye of the user views a different portion of the display 160. In other cases, there may be separate displays 160 on which the rendered images are presented for viewing by the user, such as one display 160 for each of the user's eyes.

Although FIG. 2 illustrates one example of a process 200 for visual enhancement of see-through image sequences for XR or other applications, various changes may be made to FIG. 2. For example, various components or functions in FIG. 2 may be combined, further subdivided, replicated, omitted, or rearranged and additional components or functions may be added according to particular needs. Also, while the process 200 is described as involving the processing of a sequence of image frames, the process 200 may be duplicated or repeated in order to process multiple sequences of image frames, such as a sequence of image frames for each eye of the user.

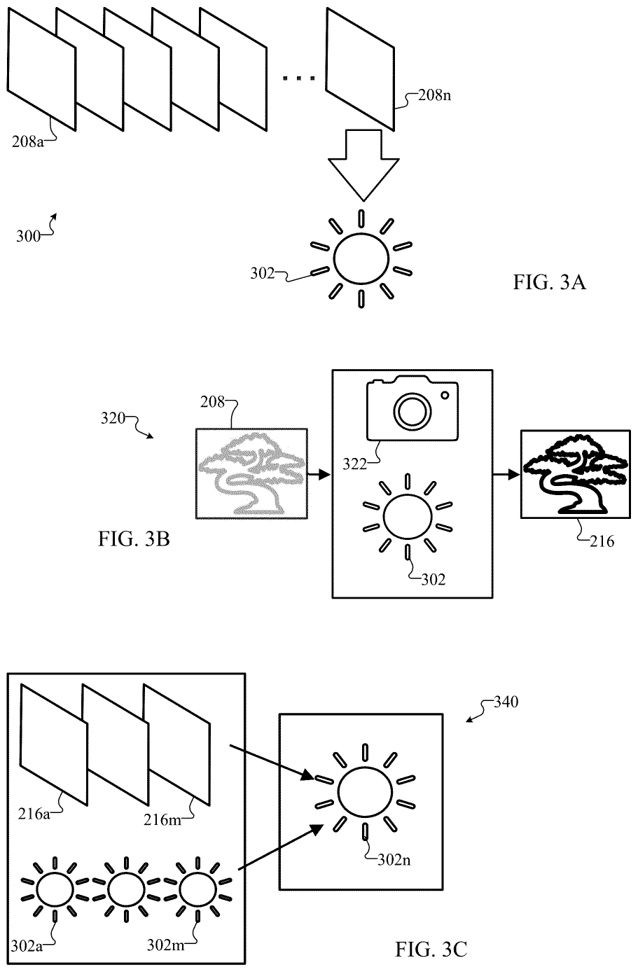

FIGS. 3A through 3C illustrate example functions in the process 200 of FIG. 2 in accordance with this disclosure. As shown in FIG. 3A, one operation associated with the process 200 is an online lightness model generation operation 300, which may occur as part of the lightness model identification function 212. During the operation 300, the electronic device 101 can process the sequence of image frames 208a-208n and, for at least some of the image frames 208a-208n, generate one or more lightness models 302. For example, each lightness model 302 may be associated with a single image frame or multiple image frames. As noted above, in some cases, at least one predefined lightness model 302 may be applied to the first image frame 208a or the first few image frames in the sequence, and the process 200 can generate additional lightness models 302 for subsequent image frames in the sequence. Also, in some cases, the lightness models 302 can be generated directly using the image frame sequence, such as by processing the image frames in an image processing pipeline.

As shown in FIG. 3B, another operation that may be associated with the process 200 is an image frame visual enhancement operation 320, which may occur as part of the visual enhancement operation 214. During the operation 320, the electronic device 101 can apply a lightness model 302 associated with an image frame 208 to that image frame 208. The electronic device 101 may also apply a response model 322 associated with the imaging sensor 180 that captured the image frame 208 to the image frame 208. This leads to the generation of an enhanced image frame 216, which represents an improved version of the image frame 208. In some cases, the response model 322 can represent a precomputed response function that is applied in the same manner to all of the image frames 208a-208n.

As shown in FIG. 3C, yet another operation that may be associated with the process 200 is a lightness model improvement operation 340, which may occur as part of the lightness model identification function 212. During the operation 340, the electronic device 101 can take an initial lightness model for an image frame and modify the initial lightness model based on one or more prior enhanced image frames and one or more prior lightness models. In this example, for instance, the lightness model 302n may be generated based on one or more prior enhanced image frames 216a-216m and one or more prior lightness models 302a-302m. Here, the lightness transform function initially generated for the lightness model 302n can be improved for the current image frame 208n using the previously-computed lightness functions for the lightness models 302a-302m and the previously-enhanced image frames 216a-216m generated using those lightness models 302a-302m.

Although FIGS. 3A through 3C illustrate examples of functions in the process 200 shown in FIG. 2, various changes may be made to FIGS. 3A through 3C. For example, any suitable number of image frames 208a-208n may be processed and any suitable number of lightness models 302 may be generated in FIG. 3A. Also, the response model 322 may or may not be used in FIG. 3B. In addition, any suitable number of prior enhanced image frames and any suitable number of prior lightness models may be used to improve each subsequent lightness model in FIG. 3C.

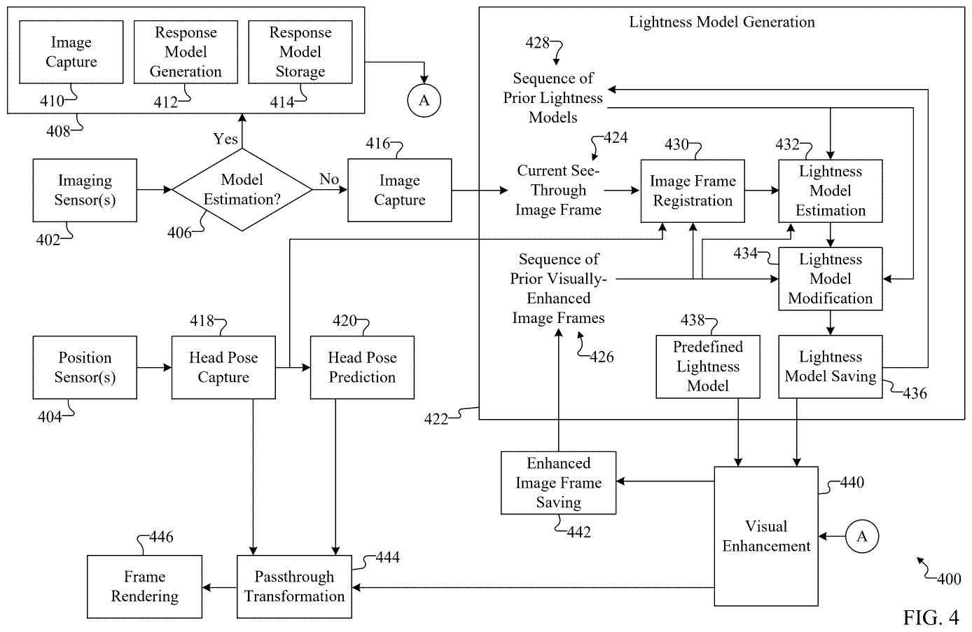

FIG. 4 illustrates an example architecture 400 supporting visual enhancement of see-through image sequences for XR or other applications in accordance with this disclosure. For ease of explanation, the architecture 400 shown in FIG. 4 is described as being implemented using the electronic device 101 in the network configuration 100 shown in FIG. 1, where the electronic device 101 may implement the process 200 shown in FIG. 2. However, the architecture 400 may be implemented using any other suitable device(s) and in any other suitable system(s), and the architecture 400 may be used to implement any other suitable process(es) designed in accordance with this disclosure.

As shown in FIG. 4, the architecture 400 is used in conjunction with one or more imaging sensors 402 and one or more position sensors 404, which may represent various sensors 180 of the electronic device 101. The one or more imaging sensors 402 provide a sequence of image frames (such as image frames 208a-208n), and the one or more position sensors 404 provide user head pose data. A determination function 406 can be used to determine whether a response model needs to be estimated. For example, the determination function 406 may determine if a request to perform response model calibration is received, such as when the electronic device 101 triggers response model calibration in response to one or more events (like image capture in a new environment).

A response model generation operation 408 generally operates to identify a response model (such as a response model 322). In this example, the response model generation operation 408 includes an image capture function 410, which can be used to obtain multiple image frames from the imaging sensor(s) 402. For instance, the image capture function 410 may be used to obtain multiple color image frames captured using the imaging sensor(s) 402. The image capture function 410 can also cause the imaging sensor(s) 402 to use different exposure settings when capturing the color image frames, such as by capturing the color image frames using different exposure times.

A response model generation function 412 generally operates to produce a response model 322 based on the color image frames. For example, the response model generation function 412 may be used to identify one or more parameters of the response model 322 based on the color image frames. As noted above, the response model 322 maps scene irradiance to image brightness or intensity, and this mapping can generally be defined using (i) irradiance on an imaging sensor 402 and (ii) one or more response parameters that describe the imaging sensor 402. Overall, the response model 322 can represent geometric, radiometric, and polarimetric characteristics of the imaging sensor 402. The response model generation function 412 can use any suitable technique(s) for generating a response model 322, and this disclosure is not limited to any particular technique for generating a response model 322. A response model storage function 414 generally operates to store the generated response model 322, such as in a memory 130 of the electronic device 101.

If generation of the response model 322 is not needed, an image capture operation 416 can be used to obtain multiple image frames from the imaging sensor(s) 402. For example, the image capture operation 416 may be used to obtain a sequence of color image frames captured using the imaging sensor(s) 402. As a particular example, the image capture operation 416 may be used to obtain a sequence of image frames 208a-208n. Any number of image frames may be included in the sequence, possibly including a large number of image frames.

A head pose capture operation 418 generally operates to obtain information related to the head pose of a user using the electronic device 101 from the one or more position sensors 404. For example, the head pose capture operation 418 may obtain inputs from an IMU, a head pose tracking camera, or other position sensor(s) 404 of the electronic device 101 while the image frames are being captured using the one or more imaging sensors 402. The information related to the head pose of the user can be provided to a head pose prediction operation 420, which generally operates to estimate what the user's head pose will likely be when rendered images are actually displayed to the user. In many cases, for instance, image frames will be captured at one time and rendered images will be subsequently displayed to the user some amount of time later, and it is possible for the user to move his or her head during this intervening time period. The head pose prediction operation 420 can therefore be used to estimate, for each image frame, what the user's head pose will likely be when a rendered image based on that image frame will be displayed to the user. The head pose prediction operation 420 may use any suitable technique(s) to predict the user's head pose, such as by using a head pose model that predicts the future pose of the user's head based on prior and current information about the user's head pose.

The captured image frames 208a-208n in the sequence being processed and the head pose information are provided to a lightness model generation operation 422, which may be used to implement the lightness model identification function 212 described above. In this example, the captured image frames 208a-208n can be processed in series, and the image frame currently being processed is identified as a current see-through image frame 424. Except for the first image frame or the first few image frames in the sequence, the lightness model generation operation 422 can also receive or have access to a sequence of prior visually-enhanced image frames 426 and a sequence of prior lightness models 428.

The current image frame 424 and at least some of the prior visually-enhanced image frames 426 are provided to an image frame registration function 430, which generally operates to determine how to align the image frames in order to produce aligned image frames. For example, the image frame registration function 430 may determine how one or more image frames would need to be warped or otherwise modified in order to more closely align one or more features in the image frames and then warp or otherwise modify the one or more image frames. Registration may be needed in order to compensate for misalignment caused by the electronic device 101 moving or rotating in between image captures, which causes objects in the image frames to move or rotate slightly (as is common with handheld devices). The image frame registration function 430 may use any suitable technique for image registration. In some cases, the image frames can be aligned both geometrically and photometrically. In particular embodiments, the image frame registration function 430 can use global Oriented FAST and Rotated BRIEF (ORB) features and local features from a block search to identify how to align the image frames. However, other implementations of the image frame registration function 430 could also be used.

A lightness model estimation function 432 generally operates to identify parameters of a lightness model for the aligned version of the current image frame 424 based on its pixel correspondences with at least some of the prior visually-enhanced image frames 426. The lightness model estimation function 432 can also use at least some of the prior lightness models 428 when identifying the parameters of the lightness model. In some embodiments, the lightness model estimation function 432 can compare the pixel values of the current image frame 424 and the corresponding pixel values of at least some of the prior visually-enhanced image frames 426. As particular examples, the lightness model estimation function 432 can use contrast and intensity information of the corresponding pixels in the image frames 424, 426 and at least some of the prior lightness models 428 to generate a lightness transform function representing the lightness model for the current image frame 424. The lightness transform function depends on the properties of the imaging sensor 180 that captured the current image frame 424 and an exposure ratio map associated with the current image frame 424. This allows parameters of the lightness transform function to be estimated based on information of corresponding pixels in the image frames 424, 426, allowing the lightness model for the current image frame 424 to be generated.

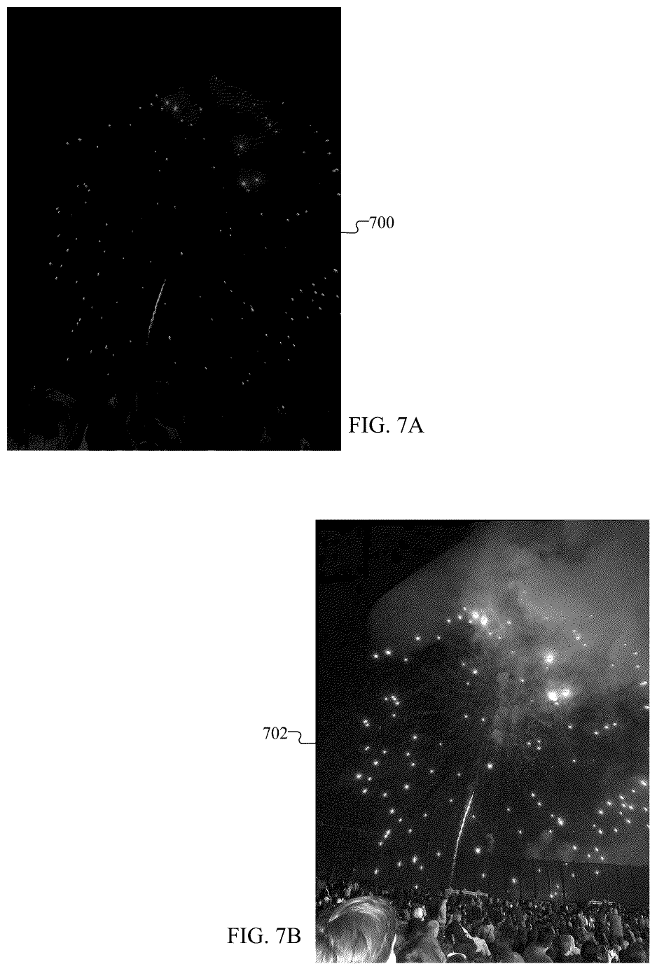

A lightness model modification function 434 generally operates to take the lightness model for the current image frame 424 produced by the lightness model estimation function 432 and modify the lightness model, such as to generate a final lightness model 302 for the current image frame 424. For example, the lightness model modification function 434 can use at least some of the prior visually-enhanced image frames 426 and at least some of the prior lightness models 428 to improve the lightness model for the current image frame 424 generated by the lightness model estimation function 432. In some cases, the lightness model modification function 434 can use signal-to-noise ratios and brightnesses of image frames in order to adjust parameters of the lightness model for the current image frame 424. One example approach for improving the lightness model for the current image frame 424 is described below in conjunction with FIG. 7. Once a final lightness model 302 for the current image frame 424 is produced, a lightness model saving function 436 can save the final lightness model 302 for the current image frame 424 to the sequence of prior lightness models 428.

To support initial processing of the first image frame or the first few image frames in the sequence, a predefined lightness model retrieval function 438 can retrieve one or more predefined lightness models, such as from a memory 130 of the electronic device 101. As noted above, while the at least one predefined lightness model may be predetermined at the time of use, the at least one predefined lightness model may be updated over time. The at least one predefined lightness model can also be saved to the sequence of prior lightness models 428.

Note that this represents one example implementation of the lightness model generation operation 422 and that other approaches may be used to generate lightness models 302. For example, a machine learning model may be trained to process image frames 208a-208n (including current and previously-enhanced image frames) and prior lightness models in order to generate a lightness model 302 for a current image frame 424. This may allow, for instance, the machine learning model to be trained in an offline manner and to be applied in an online manner.

The final lightness model 302 for the current image frame 424 (either a predefined lightness model or a generated lightness model) is provided to a visual enhancement operation 440, which may be the same as or similar to the visual enhancement operation 214 described above. For example, the visual enhancement operation 440 may apply the final lightness model 302 to the current image frame 424 in order to generate an enhanced image frame (such as an enhanced image frame 216). The visual enhancement operation 440 may also apply the response model 322 identified by the response model generation operation 408 to the current image frame 424 when generating the enhanced image frame 216. The enhanced image frame can be provided to an enhanced image frame saving operation 442, which can save the enhanced image frame for the current image frame 424 to the sequence of prior visually-enhanced image frames 426.

The enhanced image frame can also be provided to a passthrough transformation operation 444, which may be the same as or similar to the passthrough transformation operation 222 described above. For example, among other things, the passthrough transformation operation 444 can receive the head pose prediction of the user, which allows the passthrough transformation operation 444 to apply a transformation to modify the enhanced image frame based on the predicted head pose of the user. The passthrough transformation operation 444 can generate a transformed image frame that is provided to a frame rendering operation 446, which may be the same as or similar to the frame rendering operation 224 described above. The frame rendering operation 446 can render an image for display based on the transformed image frame.

Note that while the visual enhancement operation 440 here is performed after the lightness model is generated, some pre-enhancement may be performed prior to lightness model generation. For example, a global lightness adjustment may be performed on the entire current image frame 424, and noise reduction may be performed based on the resulting image frame. After that pre-processing, the lightness model for the current image frame 424 can be generated. Also or alternatively, post-processing may be performed after the visual enhancement operation 440 is performed. For instance, image re-lighting can be performed using the enhanced image frame generated by the visual enhancement operation 440 to further improve the lighting status for the whole enhanced image frame.

Although FIG. 4 illustrates one example of an architecture 400 supporting visual enhancement of see-through image sequences for XR or other applications, various changes may be made to FIG. 4. For example, various components, operations, or functions in FIG. 4 may be combined, further subdivided, replicated, omitted, or rearranged and additional components, operations, or functions may be added according to particular needs. Also, while the architecture 400 is described as processing a sequence of image frames, the architecture 400 may be duplicated or repeatedly used in order to process multiple sequences of image frames, such as a sequence of image frames for each eye of the user.

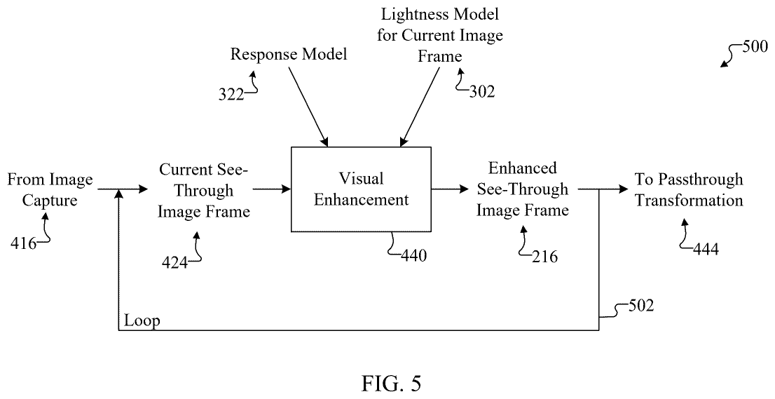

FIG. 5 illustrates an example technique 500 for visual enhancement of image frames in a see-through image sequence in accordance with this disclosure. The technique 500 may, for example, be used as part of the visual enhancement operation 440 in the architecture 400 shown in FIG. 4. For case of explanation, the technique 500 shown in FIG. 5 is described as being implemented using the electronic device 101 in the network configuration 100 shown in FIG. 1, where the electronic device 101 may implement the process 200 shown in FIG. 2 and/or the architecture 400 shown in FIG. 4. However, the technique 500 may be implemented using any other suitable device(s) and in any other suitable system(s), and the technique 500 may be used to implement any other suitable process(es) or architecture(s) designed in accordance with this disclosure.

As shown in FIG. 5, a current image frame 424 in a sequence is obtained and processed by the visual enhancement operation 440. The visual enhancement operation 440 also receives the response model 322 associated with the imaging sensor 180, 402 that captured the current image frame 424 and the lightness model 302 generated by the lightness model generation operation 422 for at least the current image frame 424. The visual enhancement operation 440 processes the current image frame 424 and applies the response model 322 and the lightness model 302 to the current image frame 424, thereby generating an enhanced image frame 216.

In some embodiments, the visual enhancement operation 440 can provide visual enhancement by identifying and applying contrast changes to the pixels in the current image frame 424. These contrast changes can adjust the brightnesses of various pixels in the current image frame 424. The contrast changes may be identified in any suitable manner, such as by integrating the contrast changes in the neighborhood around each pixel in the current image frame 424 and identifying the contrast change to be applied to that pixel. The visual enhancement operation 440 can also process neighborhoods of pixels in the current image frame 424 in order to estimate where noise is located in the current image frame 424, and the visual enhancement operation 440 can update pixel values identified as containing noise (such as by averaging the pixels in the neighborhood of a pixel containing noise). The visual enhancement operation 440 can therefore be used to adjust the brightness of the current image frame 424 and remove background or other noise.

As can be seen here, the visual enhancement operation 440 can effectively operate within a loop 502. One or more initial image frames in a sequence of image frames 208a-208n may be received and enhanced using one or more predefined lightness models, resulting in the generation of one or more initial enhanced image frames. The initial enhanced image frame(s) and the predefined lightness model(s) can be stored in the sequence of prior enhanced image frames 218, 426 and the sequence of prior lightness models 220, 428. Additional image frames in the sequence of image frames 208a-208n can continue to be processed, where a lightness model 302 can be generated for each of at least some of the additional image frames and applied by the visual enhancement operation 440.

Although FIG. 5 illustrates one example of a technique 500 for visual enhancement of image frames in a see-through image sequence, various changes may be made to FIG. 5. For example, use of the response model 322 may be optional. Also, each image frame may have its own lightness model, or a lightness model may be shared by two or more image frames as described above.

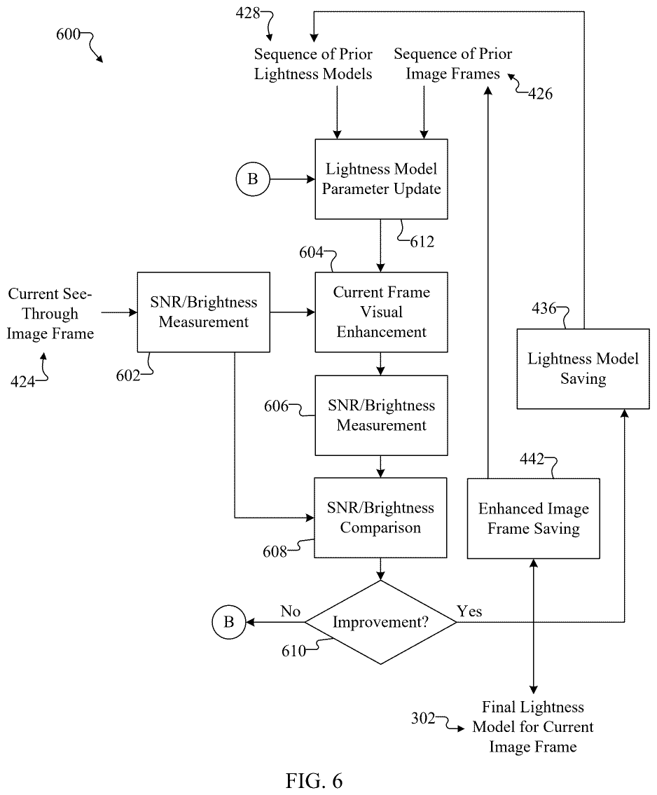

FIG. 6 illustrates an example technique 600 for improving a current lightness model based on one or more prior lightness models in accordance with this disclosure. The technique 600 may, for example, be used as part of the lightness model modification function 434 in the architecture 400 shown in FIG. 4. For case of explanation, the technique 600 shown in FIG. 6 is described as being implemented using the electronic device 101 in the network configuration 100 shown in FIG. 1, where the electronic device 101 may implement the process 200 shown in FIG. 2 and/or the architecture 400 shown in FIG. 4. However, the technique 600 may be implemented using any other suitable device(s) and in any other suitable system(s), and the technique 600 may be used to implement any other suitable process(es) or architecture(s) designed in accordance with this disclosure.

As shown in FIG. 6, the current image frame 424 is provided to a signal-to-noise ratio (SNR) and brightness measurement function 602, which generally operates to measure the SNR and the brightness level of the current image frame 424. Here, SNR_{current} can be used to represent the SNR of the current image frame 424, and B_{current}(μ, σ) can be used to represent the brightness level of the current image frame 424. Here, μ and σ represent the mean and standard deviation of the brightness values in the current image frame 424. A current frame enhancement function 604 generally operates to apply the original lightness model 302 associated with the current image frame 424 as generated by the lightness model estimation function 432 in order to generate an initial enhanced image frame.

The initial enhanced image frame is provided to an SNR and brightness measurement function 606, which generally operates to measure the SNR and the brightness level of the initial enhanced image frame. Here, SNR_{new} can be used to represent the SNR of the initial enhanced image frame, and B_{new}(μ, σ) can be used to represent the brightness level of the initial enhanced image frame. Here, μ and σ represent the mean and standard deviation of the brightness values in the initial enhanced image frame. A comparison function 608 compares the SNR and brightness values for the current image frame 424 and the initial enhanced image frame, and a determination function 610 determines if the SNR and brightness values for the initial enhanced image frame are improved relative to the SNR and brightness values for the current image frame 424.

If SNR_{new} and B_{new}(μ, σ) are not better than SNR_{current} and B_{current}(μ, σ), this is indicative that the current version of the lightness model 302 may not be effective if applied to the current image frame 424 during image enhancement. In this case, a lightness model parameter update function 612 can be applied, which generally operates to modify one or more parameters of the lightness model 302 in order to generate a modified lightness model. The lightness model parameter update function 612 can modify the one or more parameters of the lightness model 302 in any suitable manner. In some embodiments, for instance, the lightness model parameter update function 612 can perform a curve fitting function that modifies parameters of the lightness model for the current image frame 424 using parameters of the prior lightness models 428 and parameters of the prior visually-enhanced image frames 426. The modified lightness model can be provided to the current frame enhancement function 604, which can apply the modified lightness model to the current image frame 424 in order to generate an updated enhanced image frame. The updated enhanced image frame can be processed using the functions 606-610 in order to determine if the updated enhanced image frame is improved compared to the original current image frame 424.

At some point, the determination function 610 determines that the SNR and brightness values for an enhanced image frame are improved relative to the SNR and brightness values for the current image frame 424. When the determination function 610 makes this determination, the enhanced image frame saving operation 442 can be used to save the final enhanced image frame generated for the current image frame 424 into the sequence of prior visually-enhanced image frames 426, and the lightness model saving function 436 can be used to save the final lightness model 302 for the current image frame 424 into the sequence of prior lightness models 428. The final lightness model 302 for the current image frame 424 can also be output, such as for use by the visual enhancement operation 440. This approach therefore allows the initial lightness model 302 to be improved and finalized in an online manner based on information associated with the sequences 426, 428.

Although FIG. 6 illustrates one example of a technique 600 for improving a current lightness model based on one or more prior lightness models, various changes may be made to FIG. 6. For example, other or additional characteristic(s) may be used when comparing a current image frame 424 and an enhanced version of the current image frame 424.

FIGS. 7A and 7B illustrate example results obtainable using visual enhancement of see-through image sequences in accordance with this disclosure. More specifically, FIG. 7A illustrates an example output image 700 generated using a standard image processing pipeline. As can be seen here, the output image 700 is very dark and lacks significant detail. This makes it difficult for a user viewing the output image 700 to discern content in the user's environment. This can even cause user discomfort.

FIG. 7B illustrates an example output image 702 generated using the techniques described above. As can be seen here, the resulting output image 702 provides much better results compared to the output image 700. Among other reasons, this is because (while processing a sequence of image frames) the electronic device 101 is able to improve brightness and reduce noise, particularly as the electronic device 101 generates more and more lightness models for the sequence of image frames. This can result in visually-significant improvements in the quality of the resulting output images.

Although FIGS. 7A and 7B illustrate one example of results obtainable using visual enhancement of see-through image sequences, various changes may be made to FIGS. 7A and 7B. For example, FIGS. 7A and 7B are merely meant to illustrate one example of a type of benefit that might be obtained using the techniques of this disclosure. The specific results that are obtained in any given situation can vary based on the circumstances and based on the specific implementation of the techniques described in this disclosure.

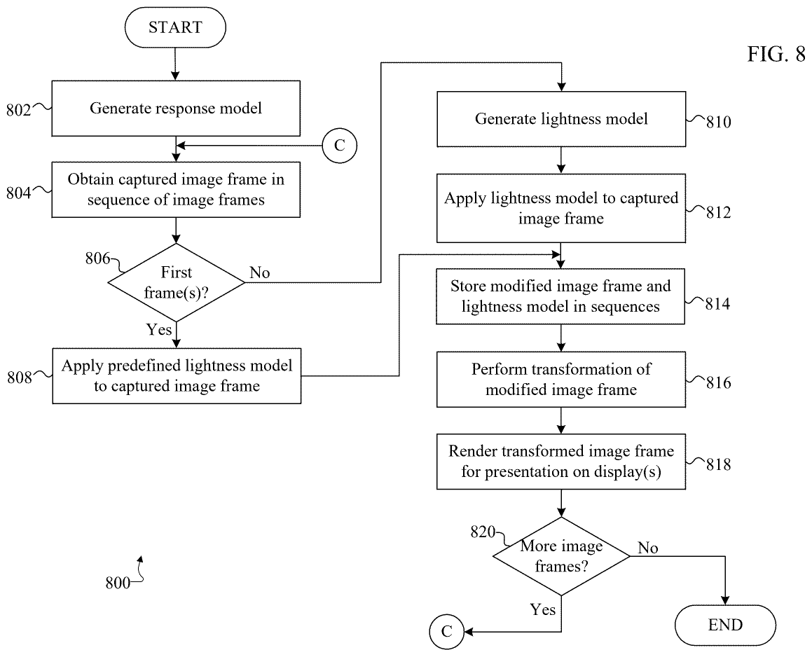

FIG. 8 illustrates an example method 800 for visual enhancement of see-through image sequences for XR or other applications in accordance with this disclosure. For case of explanation, the method 800 shown in FIG. 8 is described as being performed using the electronic device 101 in the network configuration 100 shown in FIG. 1, where the electronic device 101 may implement the process 200 shown in FIG. 2 and/or the architecture 400 of FIG. 4. However, the method 800 may be performed using any other suitable device(s) and in any other suitable system(s), and the method 800 may be implemented using any other suitable process(es) or architecture(s) designed in accordance with this disclosure.

As shown in FIG. 8, a response model is generated at step 802. This may include, for example, the processor 120 of the electronic device 101 generating a response model 322 for at least one imaging sensor 180, 402 of the electronic device 101 used to capture image frames. In some cases, the response model 322 may be generated by obtaining color image frames captured using the at least one imaging sensor 180, 402 using different exposure settings and identifying one or more parameters of the response model 322 based on the color image frames. Note, however, that use of the response model 322 is optional, in which case step 802 may be omitted.

A captured image frame in a sequence of image frames is obtained using at least one imaging sensor at step 804. This may include, for example, the processor 120 of the electronic device 101 obtaining an image frame in a sequence of image frames 208a-208n captured using the at least one imaging sensor 180, 402 of the electronic device 101. A determination is made whether the captured image frame represents the first image frame or one of the first few image frames in the sequence being processed at step 806. If so, the method 800 moves to step 808. If not, the method moves to step 810.

When the determination is made that the captured image frame represents the first image frame or one of the first few image frames in the sequence, a predefined lightness model is applied to the captured image frame in order to generate a modified image frame at step 808. This may include, for example, the processor 120 of the electronic device 101 applying a lightness model provided by the predefined lightness model retrieval function 438 to the current image frame 424 using the visual enhancement operation 440. When the determination is made that the captured image frame does not represent the first image frame or one of the first few image frames in the sequence, a lightness model for the captured image frame is generated at step 810 and applied to the captured image frame in order to generate a modified image frame at step 812. This may include, for example, the processor 120 of the electronic device 101 generating a lightness model 302 using the lightness model generation operation 422 and applying the lightness model 302 to the current image frame 424 using the visual enhancement operation 440. The generated lightness model can be based on (i) one or more previous visually-enhanced image frames associated with one or more previous image frames in the sequence and (ii) one or more previous lightness models associated with the one or more previous visually-enhanced image frames. Note that the visual enhancement operation 440 here can also apply the response model 322 to the current image frame 424 during image enhancement.

In either case, the modified image frame and the lightness model are stored in associated sequences at step 814. This may include, for example, the processor 120 of the electronic device 101 storing the modified image frame in the sequence of prior visually-enhanced image frames 426 and storing the lightness model used to produce the modified image frame in the sequence of prior lightness models 428. The resulting enhanced image frame may be used in any suitable manner. In this example, a transformation is performed using the modified image frame at step 816, and the resulting transformed image frame is rendered for display at step 818. This may include, for example, the processor 120 of the electronic device 101 applying a passthrough transformation, which could be based on a predicted head pose of the user. This may also include the processor 120 of the electronic device 101 rendering the resulting transformed image frame and displaying the rendered image on at least one display 160 of the electronic device 101. A determination is made whether one or more additional image frames in the sequence need to be processed at step 820. If so, the method 800 can return to step 804.

Although FIG. 8 illustrates one example of a method 800 for visual enhancement of see-through image sequences for XR or other applications, various changes may be made to FIG. 8. For example, while shown as a series of steps, various steps in FIG. 8 may overlap, occur in parallel, occur in a different order, or occur any number of times (including zero times). Also, while the method 800 is described as processing a sequence of image frames, the method 800 may be duplicated or repeatedly used in order to process multiple sequences of image frames, such as a sequence of image frames for each eye of the user.

It should be noted that the functions shown in or described with respect to FIGS. 2 through 8 can be implemented in an electronic device 101, 102, 104, server 106, or other device(s) in any suitable manner. For example, in some embodiments, at least some of the functions shown in or described with respect to FIGS. 2 through 8 can be implemented or supported using one or more software applications or other software instructions that are executed by the processor 120 of the electronic device 101, 102, 104, server 106, or other device(s). In other embodiments, at least some of the functions shown in or described with respect to FIGS. 2 through 8 can be implemented or supported using dedicated hardware components. In general, the functions shown in or described with respect to FIGS. 2 through 8 can be performed using any suitable hardware or any suitable combination of hardware and software/firmware instructions. Also, the functions shown in or described with respect to FIGS. 2 through 8 can be performed by a single device or by multiple devices.

Although this disclosure has been described with example embodiments, various changes and modifications may be suggested to one skilled in the art. It is intended that this disclosure encompass such changes and modifications as fall within the scope of the appended claims.

What is claimed is:

1. An apparatus comprising:
at least one imaging sensor configured to capture a sequence of image frames; and
at least one processing device configured, for each of at least some of the captured image frames, to:
generate a lightness model associated with the captured image frame, the lightness model based on (i) one or more previous visually-enhanced image frames associated with one or more previous image frames in the sequence and (ii) one or more previous lightness models associated with the one or more previous visually-enhanced image frames;
apply the lightness model to the captured image frame in order to generate a modified captured image frame; and
render an image for display based on the modified captured image frame.

2. The apparatus of claim 1, wherein, to generate the lightness model for each of at least some of the captured image frames, the at least one processing device is configured to identify (i) one or more parameters of a lightness transform function based on one or more properties of the at least one imaging sensor and (ii) an exposure ratio map associated with the captured image frame.

3. The apparatus of claim 1, wherein, for each of at least some of the captured image frames, the at least one processing device is configured to apply both the lightness model and a response model in order to generate the modified captured image frame, the response model associated with the at least one imaging sensor.

4. The apparatus of claim 3, wherein:
the at least one processing device is further configured to generate the response model; and
to generate the response model, the at least one processing device is configured to:
obtain color image frames captured using the at least one imaging sensor, different color image frames captured using different exposure settings; and
identify one or more parameters of the response model based on the color image frames.

5. The apparatus of claim 1, wherein:
the at least one processing device is further configured to apply a transformation to the modified captured image frame in order to generate a transformed image frame; and
to render the image for display, the at least one processing device is configured to render the transformed image frame.

6. The apparatus of claim 1, wherein, to generate the lightness model for each of at least some of the captured image frames, the at least one processing device is configured to:
perform registration between the captured image frame and the one or more previous visually-enhanced image frames to obtain pixel correspondences between the image frames; and
determine one or more parameters of the lightness model based on the pixel correspondences.

7. The apparatus of claim 1, wherein the at least one processing device is further configured to:
save the modified captured image frame as part of a sequence of previous visually-enhanced image frames;
save the lightness model as part of a sequence of previous lightness models; and
process an additional image frame in the sequence of image frames based on the sequence of previous visually-enhanced image frames and the sequence of previous lightness models.

8. The apparatus of claim 1, wherein the at least one processing device is further configured to:
apply at least one predefined lightness model to one or more initial captured image frames in the sequence in order to generate at least one of the one or more previous visually-enhanced image frames; and
use the at least one predefined lightness model as at least one of the one or more previous lightness models.

9. A method comprising:
obtaining a sequence of captured image frames using at least one imaging sensor; and
for each of at least some of the captured image frames:
generating a lightness model associated with the captured image frame, the lightness model based on (i) one or more previous visually-enhanced image frames associated with one or more previous image frames in the sequence and (ii) one or more previous lightness models associated with the one or more previous visually-enhanced image frames;
applying the lightness model to the captured image frame in order to generate a modified captured image frame; and
rendering an image for display based on the modified captured image frame.

10. The method of claim 9, wherein generating the lightness model for each of at least some of the captured image frames comprises identifying (i) one or more parameters of a lightness transform function based on one or more properties of the at least one imaging sensor and (ii) an exposure ratio map associated with the captured image frame.

11. The method of claim 9, wherein:
for each of at least some of the captured image frames, both the lightness model and a response model are applied in order to generate the modified captured image frame, the response model associated with the at least one imaging sensor; and
the response model is generated by:
obtaining color image frames captured using the at least one imaging sensor, different color image frames captured using different exposure settings; and
identifying one or more parameters of the response model based on the color image frames.

12. The method of claim 9, further comprising:
applying a transformation to the modified captured image frame in order to generate a transformed image frame;
wherein rendering the image for display comprises rendering the transformed image frame.

13. The method of claim 9, wherein generating the lightness model for each of at least some of the captured image frames comprises:
performing registration between the captured image frame and the one or more previous visually-enhanced image frames to obtain pixel correspondences between the image frames; and
determining one or more parameters of the lightness model based on the pixel correspondences.

14. The method of claim 9, further comprising:
saving the modified captured image frame as part of a sequence of previous visually-enhanced image frames;
saving the lightness model as part of a sequence of previous lightness models; and
processing an additional image frame in the sequence of image frames based on the sequence of previous visually-enhanced image frames and the sequence of previous lightness models.

15. The method of claim 9, further comprising:
applying at least one predefined lightness model to one or more initial captured image frames in the sequence in order to generate at least one of the one or more previous visually-enhanced image frames; and
using the at least one predefined lightness model as at least one of the one or more previous lightness models.

16. A non-transitory machine readable medium containing instructions that when executed cause at least one processor of an electronic device to:
obtain a sequence of captured image frames using at least one imaging sensor; and
for each of at least some of the captured image frames:
generate a lightness model associated with the captured image frame, the lightness model based on (i) one or more previous visually-enhanced image frames associated with one or more previous image frames in the sequence and (ii) one or more previous lightness models associated with the one or more previous visually-enhanced image frames;
apply the lightness model to the captured image frame in order to generate a modified captured image frame; and
render an image for display based on the modified captured image frame.

17. The non-transitory machine readable medium of claim 16, wherein the instructions that when executed cause the at least one processor to generate the lightness model for each of at least some of the captured image frames comprise:
instructions that when executed cause the at least one processor to identify (i) one or more parameters of a lightness transform function based on one or more properties of the at least one imaging sensor and (ii) an exposure ratio map associated with the captured image frame.

18. The non-transitory machine readable medium of claim 16, further containing instructions that when executed cause the at least one processor to generate a response model, the response model associated with the at least one imaging sensor;
the instructions when executed cause the at least one processor, for each of at least some of the captured image frames, to apply both the lightness model and the response model in order to generate the modified captured image frame; and
the instructions that when executed cause the at least one processor to generate the response model comprise instructions that when executed cause the at least one processor to:
obtain color image frames captured using the at least one imaging sensor, different color image frames captured using different exposure settings; and
identify one or more parameters of the response model based on the color image frames.

19. The non-transitory machine readable medium of claim 16, wherein the instructions that when executed cause the at least one processor to generate the lightness model for each of at least some of the captured image frames comprise instructions that when executed cause the at least one processor to:
perform registration between the captured image frame and the one or more previous visually-enhanced image frames to obtain pixel correspondences between the image frames; and
determine one or more parameters of the lightness model based on the pixel correspondences.

20. The non-transitory machine readable medium of claim 16, further containing instructions that when executed cause the at least one processor to:
apply at least one predefined lightness model to one or more initial captured image frames in the sequence in order to generate at least one of the one or more previous visually-enhanced image frames; and
use the at least one predefined lightness model as at least one of the one or more previous lightness models.
